(19) United States
(12) Patent Application Publication
(10) Pub. No.: US 2024/0060510 A1
(43) Pub. Date: Feb. 22, 2024

(54) METHOD AND APPARATUS FOR ENDWALL TREATMENTS

(71) Applicant: General Electric Company, Schenectady, NY (US)

(72) Inventors: Stephan Priebe, Niskayuna, NY (US); Giridhar Jothiprasad, Clifton Park, NY (US); Joseph Capozzi, North Reading, MA (US); Thomas Malkus, Albany, NY (US); Michael Macrorie, Winchester, MA (US); Trevor H. Wood, Clifton Park, NY (US)

(21) Appl. No.: 18/234,055

(22) Filed: Aug. 15, 2023

Related U.S. Application Data
(63) Continuation-in-part of application No. 17/889,542, filed on Aug. 17, 2022.

(51) Int. Cl. F04D 29/52; F04D 29/32

(52) U.S. Cl. CPC F04D 29/526; F04D 29/324

(57) ABSTRACT

A turbomachine for an aircraft is provided. The turbomachine includes a plurality of radially-extending blades and an annular endwall opposite the radially-extending blades. The endwall includes an endwall treatment recessed into the endwall. The endwall treatment is characterized by a casing treatment volume compressibility factor (CTVCF), and a casing treatment normalized volume (CTNV), and a blade tip Mach number (Mtip).

### CROSS-REFERENCE TO RELATED APPLICATIONS

This application is a continuation-in-part of U.S. patent application Ser. No. 17/889,542, filed Aug. 17, 2022, entitled “METHOD AND APPARATUS FOR ENDWALL TREATMENTS,” which is incorporated by reference in its entirety herein.

### FIELD

This application is generally directed to turbine engines and, more particularly, to operating ranges for compressors.

### BACKGROUND

In one form, a gas turbine engine can include a fan and a core arranged in flow communication with one another. The core generally includes, in serial flow order, a compressor section, a combustion section, a turbine section, and an exhaust section. In operation, air flows from the fan to the compressor section where one or more compressors progressively compress the air until it reaches the combustion section. Fuel is mixed with the compressed air and is burned within the combustion section to generate combustion gases. The combustion gases flow from the combustion section to the turbine section. The flow of combustion gases through the turbine section drives the turbine section and then flows through the exhaust section to atmosphere.

Turbofan gas turbine engines typically include a fan assembly that channels air to the core and a bypass duct. Gas turbine engines, such as turbofans, generally include fan casings that surround the fan assembly including the fan blades. The compressor section typically includes one or more compressors with corresponding compressor casings.

A compressor section for a gas turbine engine may include stages arranged along an axis of the compressor. Each stage may include a rotor disk with compressor blades, also referred to as rotor blades. In addition, each stage may further include stator blades disposed adjacent the rotor blades and arranged about a circumference of the compressor casing.

### BRIEF DESCRIPTION OF THE DRAWINGS

A full and enabling disclosure of the present disclosure, including the best mode thereof, directed to one of ordinary skill in the art, is set forth in the specification, which reference to the appended figures, in which:

FIG. 1 is a side-elevational sectional view (Z-R plane) of a turbine engine in accordance with exemplary aspects of the present disclosure;

FIG. 2 is a schematic side-elevational view (Z-R plane) of a rotary component of a turbine engine in accordance with exemplary aspects of the present disclosure;

FIG. 3A is a schematic side elevation view (Z-R plane) along a circumferential axis showing a semicircular endwall treatment in accordance with exemplary aspects of the present disclosure;

FIG. 3B is a schematic top plan view (Z-θ plane) along a radial axis showing semicircular skewed endwall treatments of FIG. 3A in accordance with exemplary aspects of the present disclosure;

FIG. 3C is a schematic side elevation view (θ-R plane) along an axial axis showing semicircular skewed endwall treatments of FIG. 3A in accordance with exemplary aspects of the present disclosure;

FIG. 4A is a schematic side elevation view along a circumferential axis showing an axial slot endwall treatment in accordance with exemplary aspects of the present disclosure;

FIG. 4B is a schematic top plan view along a radial axis showing axial slot endwall treatments of FIG. 4A in accordance with exemplary aspects of the present disclosure;

FIG. 4C is a schematic side elevation view along an axial axis showing axial slot endwall treatments of FIG. 4A in accordance with exemplary aspects of the present disclosure;

FIG. 5A is a schematic side elevation view along a circumferential axis showing an “S”-shaped groove endwall treatment in accordance with exemplary aspects of the present disclosure;

FIG. 5B is a schematic top plan view along a radial axis showing “S”-shaped groove endwall treatments of FIG. 5A in accordance with exemplary aspects of the present disclosure;

FIG. 5C is a schematic side elevation view along an axial axis showing “S”-shaped groove endwall treatments of FIG. 5A in accordance with exemplary aspects of the present disclosure;

FIG. 6A is a schematic side elevation view along a circumferential axis showing an “L”-shaped groove endwall treatment in accordance with exemplary aspects of the present disclosure;

FIG. 6B is a schematic top plan view along a radial axis showing “L”-shaped groove endwall treatments of FIG. 6A in accordance with exemplary aspects of the present disclosure;

FIG. 6C is a schematic side elevation view along an axial axis showing “L”-shaped groove endwall treatments of FIG. 6A in accordance with exemplary aspects of the present disclosure;

FIG. 7A is a schematic side elevation view along a circumferential axis showing an spiral-shaped groove endwall treatment in accordance with exemplary aspects of the present disclosure;

FIG. 7B is a schematic top plan view along a radial axis showing spiral-shaped groove endwall treatments of FIG. 7A in accordance with exemplary aspects of the present disclosure;

FIG. 7C is a perspective view showing spiral-shaped groove endwall treatments of FIG. 7A in accordance with exemplary aspects of the present disclosure; and

FIG. 8 is a graph showing exemplary endwall treatment volumes plotted in accordance with exemplary aspects of the present disclosure.

### DETAILED DESCRIPTION

Reference will now be made in detail to embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first” and “second” may be used interchangeably to distinguish one component from another and are not intended to signify location or importance of the individual components.

The term “forward” refers to a relative position within a gas turbine engine or vehicle and refers to the normal operational attitude of the gas turbine engine or vehicle. For example, with a gas turbine engine, forward refers to a position closer to an engine inlet relative to an engine exhaust.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows.

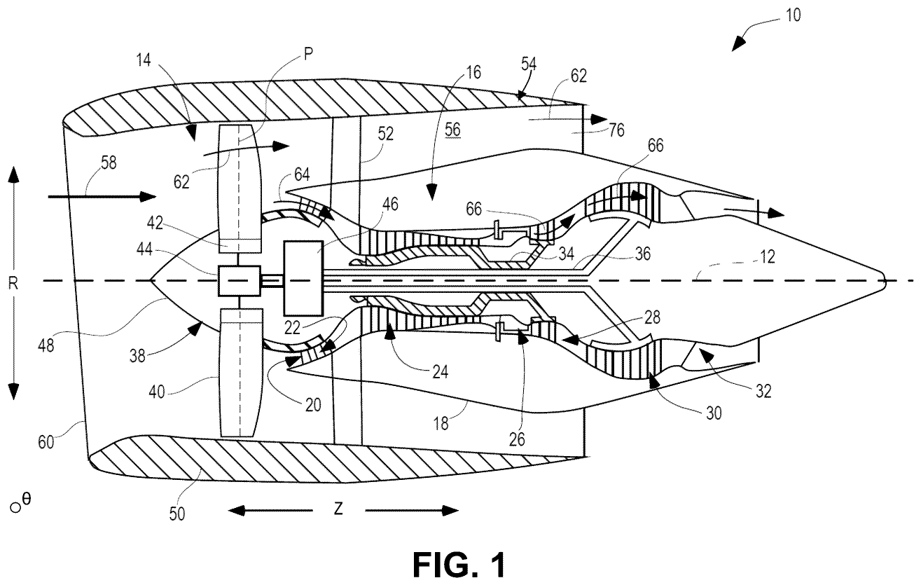

The term “axial” refers to the axis of rotation of the component on which the endwall treatment is being applied. For example, for an endwall treatment that is applied on one of the stages of the compressor, an “axial” axis extends parallel to the axis of rotation of the compressor (e.g., in the Z direction parallel to a longitudinal centerline 12 of FIG. 1).

The terms “radial” or “radially” refer to a direction away from a common center. For example, in the overall context of a turbine engine, radial refers to a direction along a ray extending between a center longitudinal axis of the engine and an outer engine circumference. In the context of an endwall treatment applied on one of the stages of the compressor, “radial” refers to a direction along a ray extending between the rotation axis of the compressor and an outer casing of the compressor.

The term “circumferential” refers to the direction circumscribing about the rotation axis or centerline. Hence, the circumferential direction is perpendicular to both the radial and axial directions.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, “generally”, and “substantially”, are not to be limited to the precise value specified. In at least some instances, the approximating language may correspond to the precision of an instrument for measuring the value, or the precision of the methods or machines for constructing or manufacturing the components and/or systems. Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

During operation of a compressor, a portion of airflow through the compressor passes over a rotor blade tip, which portion of airflow may be referred to as leakage flow or tip leakage flow. Excessive leakage flow interaction with the main flow can reduce stall margin and overall margin built into the core of a gas turbine engine. The inventors, in an effort to increase the stable operating range for a compressor, considered flow control-based techniques, such as plasma actuation and suction/blowing near a blade tip to reduce leakage. These attempts were found unsatisfactory, as they tended to increase compressor complexity and weight.

Another approach was to apply endwall or casing treatments (endwall treatment, for purposes of this disclosure, has the same meaning as casing treatment). These treatments include recesses such as patterned grooves or slots that define volumes formed in the endwall. With increased compressibility of the flow, smaller endwall treatment volumes are desirable. Also, such smaller endwall treatments are advantageous from a manufacturing and mechanical standpoint. Choosing the volume too large may not be advantageous from a manufacturing and mechanical standpoint, and it may also incur a higher aerodynamic efficiency penalty. The inventors evaluated several embodiments of these endwall treatments with these trade-offs in mind, as described in greater detail below. Casing treatment designs are typically derived through multiple unsteady computational fluid dynamics simulations. These simulations are typically computationally expensive.

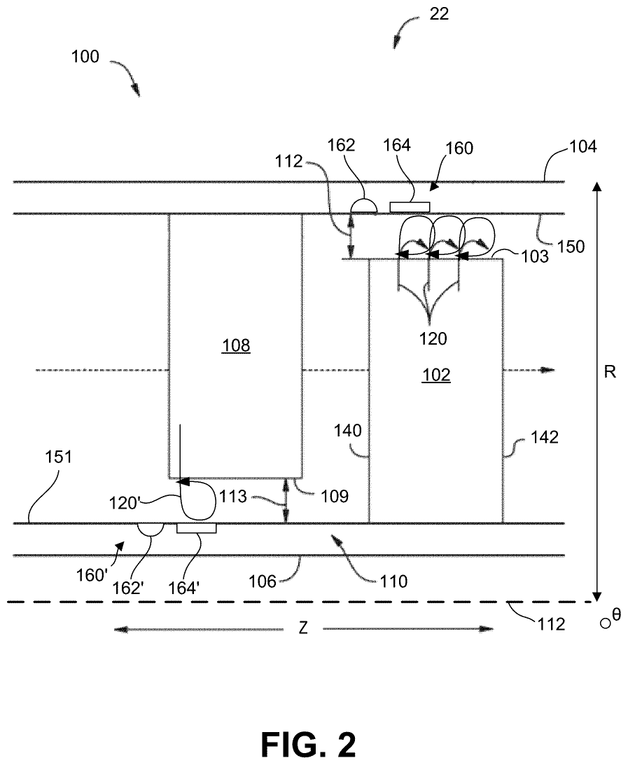

As explained in greater detail below, after evaluation of numerous embodiments for endwall treatments, it was found, unexpectedly, that there exist certain relationships between the flow compressibility at the compressor blading and the particular casing treatment needed to improve results in terms of increased stable operating range for the compressor. The flow compressibility at the compressor blading is characterized by the blade tip Mach number (MTip) and plays a role in the choice of the endwall treatment. The relative velocity between the blade row and the endwall with the endwall treatment is used to define the blade tip Mach Number (MTip). For a rotating blade row (rotor), the speed of blade rotation should be used to determine the blade tip Mach number (Mtip). For a stationary blade row (stator), the speed of rotation of the endwall (hub) defines the Mtip. FIG. 2 provides an illustrative example.

Aspects and advantages of the present disclosure will be set forth in part in the following description, or may be obvious from the description, or may be learned through practice of the present disclosure.

Various aspects of the present disclosure facilitate achieving improved endwall treatments for a casing that encircles blade tips, such as those of a compressor or a fan in a gas turbine engine. These teachings include the selection of an endwall or casing treatment volume within a design space using an endwall or casing treatment compressibility factor. This aids in achieving a casing treatment volume that provides both improvements in performance and manufacturing of the subject engine.

In one exemplary embodiment of the present disclosure, a turbomachine for an aircraft is provided. The turbomachine includes a plurality of radially-extending blades and an annular endwall opposite the radially-extending blades. The endwall includes an endwall treatment recessed into the endwall. The endwall treatment has a casing treatment volume compressibility factor (CTVCF) as a function of casing treatment normalized volume (CTNV) and a blade tip Mach number (Mtip) according to CTVCF=CTNV+2.2*Mtip^{1.4}. CTNV=100*(CTAxLen/Cax)*(CTRadHt/RotHt)*(CTCircumWid*NCT/(2*pi*Rtip)).

CTAxLen represents the maximum axial extent occupied by each endwall treatment groove. CTRadHt is a radial height between a distance from a surface of the annular endwall and a furthest radial dimension of the endwall treatment from the surface. CTCircumWid represents a circumferential maximum width of a casing treatment groove over the axial-cuts wherein the endwall treatments are located. NCT is a number of endwall treatment slots or grooves per blade row. Cax is a blade axial chord length measured in a tip section of a blade closest to the endwall with the endwall treatment. RotHt is a blade height. Rtip is a blade tip radius. Mtip is a blade tip Mach number equal to (relative speed between blade tip and an endwall with an endwall treatment while rotating at 90% of the engine redline speed for the shaft in which the turbomachine is located/(speed of sound).

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

Referring now to the drawings, wherein identical numerals indicate the same elements throughout the figures, FIG. 1 is a schematic, cross-sectional view of a turbomachine, more specifically a gas turbine engine, in accordance with an exemplary embodiment of the present disclosure. More particularly, for the embodiment of FIG. 1, the gas turbine engine is a high-bypass turbofan jet engine 10, referred to herein as “turbofan jet engine 10.” As shown in FIG. 1, the turbofan jet engine 10 defines an axial direction Z (extending parallel to a longitudinal centerline 12 provided for reference), a radial direction R, and a circumferential direction θ. In general, the turbofan jet engine 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the high pressure turbine 28 to the high pressure compressor 24. A low pressure (LP) shaft or spool 36 drivingly connects the low pressure turbine 30 to the low pressure compressor 22.

Fan blades 40 extend outwardly from disk 42 generally along the radial direction R. For the embodiment depicted, the fan section 14 includes a variable pitch fan 38 having a plurality of fan blades 40 coupled to a disk 42 in a spaced apart manner. One or more of the fan blades 40 may be rotatable relative to the disk 42 about a pitch axis P by virtue of the fan blades 40 being operatively coupled to a suitable actuation member 44 configured to collectively vary the pitch of the fan blades 40 in unison. The fan blades 40, disk 42, and actuation member 44 may be together rotatable about the longitudinal centerline 12 by low pressure spool 36 across a power gear box 46. The power gear box 46 includes a plurality of gears for stepping down the rotational speed of the low pressure spool 36 to a more efficient rotational fan speed.

The disk 42 is covered by rotatable front hub 48 aerodynamically contoured to promote an airflow through the plurality of fan blades 40. Additionally, the exemplary fan section 14 includes an annular fan casing or outer nacelle 50 that circumferentially surrounds the variable pitch fan 38 and/or at least a portion of the core turbine engine 16. It should be appreciated that the outer nacelle 50 may be configured to be supported relative to the core turbine engine 16 by a plurality of circumferentially-spaced outlet guide vanes 52. Moreover, a downstream section 54 of the outer nacelle 50 may extend over an outer portion of the core turbine engine 16 so as to define a bypass airflow passage 56 therebetween.

During operation of the turbofan jet engine 10, a volume of air 58 enters the turbofan jet engine 10 through an associated inlet 60 of the outer nacelle 50 and/or fan section 14. As the volume of air 58 passes across the fan blades 40, a first portion 62 of the air 58 as indicated by arrow 62 is directed or routed into the bypass airflow passage 56 and a second portion 64 of the air 58 as indicated by arrow 64 is directed or routed into the low pressure compressor 22. The ratio between the first portion 62 of air 58 and the second portion 64 of air 58 is commonly known as a bypass ratio. The pressure of the second portion 64 of air 58 is then increased as it is routed through the low pressure (LP) compressor 22, the high pressure (HP) compressor 24 and into the combustion section 26, where it is mixed with fuel and burned to provide combustion gases 66. Subsequently, the combustion gases 66 are routed through the high pressure turbine 28 and the low pressure turbine 30, where a portion of thermal and/or kinetic energy from the combustion gases 66 is extracted.

The combustion gases 66 are then routed through the jet exhaust nozzle section 32 of the core turbine engine 16 to provide propulsive thrust. Simultaneously, the axial momentum of the first portion 62 of air 58 is substantially increased as the first portion 62 of air 58 is routed through the bypass airflow passage 56 before it is exhausted from a fan nozzle exhaust section 76 of the turbofan jet engine 10, also providing propulsive thrust.

It should be appreciated, however, that the turbofan jet engine 10 depicted in FIG. 1 is by way of example only, and that in other exemplary embodiments, aspects of the present disclosure may additionally, or alternatively, be applied to any other suitable gas turbine engine. For example, in other exemplary embodiments, the turbofan jet engine 10 may instead be any other suitable aeronautical gas turbine engine, such as a turbojet engine, turboshaft engine, turboprop engine, etc. Additionally, in still other exemplary embodiments, the turbofan jet engine 10 may include or be operably connected to any other suitable accessory systems. Other engine configurations and architectures may include multiple spools (e.g., two or more than two spools), open fans (e.g., without an outer nacelle), geared architectures, or multi-stage fans.

For the sake of an illustrative example, the following description will present applying features such as end-wall treatments in a gas turbine engine such as the turbofan jet engine 10 described above. It shall be understood that the specifics of these details are intended to serve an illustrative purpose and are not intended to suggest any limitations as to the scope of these teachings.

Referring now to FIG. 2, a rotary component 100 of the turbofan jet engine 10 is illustrated. As shown, the rotary component 100 is configured as a portion of the LP compressor 22, though it should be appreciated that the rotary component 100 may also correspond to the HP compressor 24, the fan section 14, or an intermediate compressor (not shown). The rotary component may also be applied to an electrically driven ducted fan or rotor 11 such as electrically distributed propulsors used in eVTOL aircraft engines.

The rotary component 100 includes one or more sets of circumferentially-spaced rotor blades 102, such as LP compressor blades, that extend radially outward from a hub 106 towards an outer casing 104. As such, the rotor blades 102 may be coupled to a rotating shaft such as an LP shaft. The outer casing 104 may be arranged radially-outwardly of the rotor blades 102 in the radial direction R.

One or more sets of circumferentially-spaced stator blades or vanes 108 (of which only a single stator vane 108 is shown in FIG. 2) may be positioned adjacent to each set of rotor blades 102 The stator vanes 108 may be static compressor vanes that are securely coupled to the outer casing 104 and that extend radially inward towards the hub 106. The stator vanes 108 in combination with the rotor blades 102 form one of a plurality of stages 110 (of which only a single stage is shown in FIG. 2). In other embodiments, the rotary component 100 may not include stator vanes 108, such as when the rotary component 100 is the fan section 14. In some embodiments, the number of HP compressor stages may be between 8 and 10 stages, or 8 and 9 stages and the number of LP compressor stages may be 3 or 4.

Each of the rotor blades 102 may be circumscribed by the outer casing 104, such that an annular gap 112 is defined between the outer casing 104 and a rotor blade tip 103 (which may be referred to as a blade tip section or region) of each rotor blade 102. Likewise, the stator vanes 108 are disposed relative to the hub 106, such that an annular gap 113 is defined between the hub 106 and a stator vane tip 109 of each of the stator vanes 108. The rotating parts of rotary component 100 (like rotor blade 102 and hub 106) are rotatable about the centerline or axis of rotation 12.

During operation, an operating range of the rotary component 100 may be limited due to leakage flow, as indicated by directional arrows 120, 120′, proximate the rotor blade tips 103 and stator vane tips 109. Further, the leakage flow leaking over the blade tip region can roll up into vortices, creating further inefficiencies in the performance of the system.

A specific rotor stall point is determined by the operating conditions and the rotary component design. To increase the range of this operation, the rotary component 100 includes endwall treatments to minimize tip flow blockage 120, 120′. For example, the outer casing 104 may have an inner surface 150, which may be in the form of an annular endwall, from which casing or endwall treatment features 160 extend into the endwall. Additionally or alternatively, the hub 106 may have a radially-outwardly facing surface 151, which may be in the form of an annular endwall, into which casing or endwall treatments 160′ extend radially-inwardly.

For instance, the endwall treatment features, indicated generally at 160, may include one or more semicircular slots 162, 162′ and/or axial slots 164, 164′ extending generally along the axial direction Z. Although shown having semicircular slots 162, 162′ and axial slots 164, 164′, the rotary component 100 may be provided with semicircular slots 162, semicircular slots 162′, axial slots 164, axial slots 164′, or any combination thereof. Other endwall treatment features 160 may additionally or alternatively be provided, as discussed in greater detail below.

Endwall treatment features 160 may be formed in the outer casing 104 after manufacturing the outer casing 104 (e.g., feature(s) 160 may be machined in the inner surface 150 of the outer casing 104). In other embodiments, feature(s) 160 may be formed integrally with the outer casing 104 (e.g., features 160 may be formed in the outer casing 104 during an additive manufacturing process or casting process).

Additionally or alternatively, endwall treatment features 160′ may be formed in the hub 106 after manufacturing the hub 106 (e.g., feature(s) 160′ may be machined in the radially-outwardly facing surface 151 of the hub 106). In other embodiments, feature(s) 160′ may be formed integrally with the hub 106 (e.g., features 160′ may be formed in the hub 106 during an additive manufacturing process or casting process).

As further illustrated in FIG. 2, one or more of the endwall treatment features 160, 160′ may be positioned radially outward from one or more of the rotor blades 102 or radially inward from the one or more stator vanes 108. Further, the endwall treatment features 160, 160′ may be arranged axially upstream of the leading edge of the rotor blades 102 or stator vanes 108, may axially overlap the leading edge of the rotor blades 102 or stator vanes 108, or may be arranged axially downstream of the leading edge of the rotor blades 102 or stator vanes 108. For example, the feature(s) 160 may be positioned axially between a leading edge 140 and a trailing edge 142 of the rotor blade(s) 102. As such, the feature(s) 160 may be positioned in one or more of the annular gaps 112 positioned between the rotor blade tips 103 and the outer casing 104 at a stage 110 of the rotary component. In further embodiments, one or more of the features 160 may be positioned at least partially axially-forwardly of the leading edge 140 or at least partially axially-rearwardly of trailing edge 142 of the rotor blade(s) 102.

As discussed above, determining the casing or endwall treatment volume is typically a labor and time intensive process. It commonly involves an iterative process including selecting an initial endwall treatment volume, evaluating whether the volume results in a suitable engine performance (e.g., suitable stall margin), and modifying the volume in accordance with testing. It would be desirable to have a limited or narrowed range of initial endwall treatment volumes from which to begin consideration.

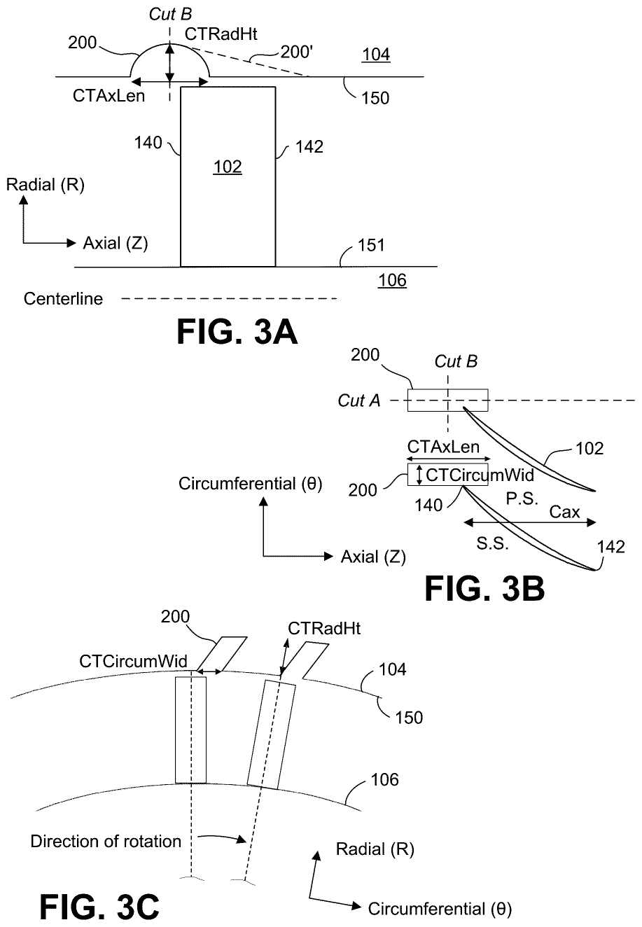

The inventors constructed several embodiments of casing treatments for different types of gas turbine engines. These casing treatments were designed and tested for compressors and fans. Examples of the casing treatments considered by the inventors are described in FIGS. 3A-3C, 4A-4C, 5A-5C, 6A-6C, 7A-7C, and the accompanying text. Such endwall treatments may be applied, for example, at a turbine engine's fan casing or hub, low-pressure compressor casing or hub, high-pressure compressor casing or hub, or intermediate-pressure compressor casing or hub. For a rotating blade row (e.g., rotor 120 in FIG. 2), the endwall treatment 162, 164 is generally located in the stationary casing and has a relative motion with respect to the rotating blade row. There is a gap between the rotating blade row and the stationary casing. The region of the rotor that is radially closest to the stationary casing is the tip region 103. For a cantilevered stator (stationary blade row 108), the blade row is stationary but the hub is rotating. As there is a relative motion between the hub and the stator, the endwall treatment 162′, 164′ is located in the rotating hub. The tip 109 is the region closest to the rotating hub. During the course of designing and testing these various casing treatment, it was discovered unexpectedly that there exists a relationship between fluid compressibility and casing or endwall treatment slot volume that uniquely expresses the desirable casing treatment for a particular engine environment. Moreover, this relationship is effective in taking into account the trade-offs mentioned earlier when designing a casing treatment. The relationship is beneficial to determining casing treatment volumes for an engine. The inventors discovered a casing treatment volume compressibility factor (CTVCF) as a function of the relationship between casing treatment normalized volume (CTNV) and fluid compressibility (as corresponding to the Mtip variable discussed in greater detail below):

CTVCF=CTNV+2.2*Mtip^{1.4} (1)

The casing treatment normalized volume (CTNV) is representative of an effective volume of the casing treatment and is expressed as follows:

CTNV=100*(CTAxLen/Cax)*(CTRadHt/RotHt)*(CTCircumWid*NCT/(2*pi*Rtip)) (2)

CTNV may alternatively be expressed as

100*(CTAxLen*CTRadHt*CTCircumWid*NCT)/(Cax*RotHt*2*π*Rtip) (2′)

Referring to FIGS. 3A, 3B, and 3C, the CTAxLen, CTRadHt, and CTCircumWid dimensions used to determine CTNV are shown with example casing treatments 200 formed in an outer casing which may correspond to outer casing 104 of FIG. 2. The casing treatments 200 are in the form of slots that have a semicircular cross-section when viewed in a circumferential direction (FIGS. 3A, cross-section in Cut A in FIG. 3B), have a rectangular cross-section when viewed in a radial direction (FIG. 3B), and have a skewed parallelogram cross-section when viewed along the axis of rotation (see FIG. 3C, cross-section in Cut B in FIG. 3B). The casing treatments 200 may be skewed, for example, approximately 45 degrees relative to the radial direction and in the rotational direction of the blade (e.g., rotor blade 102).

The casing treatments 200 have an axial length (CTAxLen) defined by an axial dimension of the casing treatments 200 as measured at the inner surface 150 of the outer casing 104. CTAxLen is defined as the maximum axial extent occupied by each casing treatment 200 as measured at the inner surface 150 of the outer casing 104. For a semicircular slot, CTAxLen corresponds to the diameter of the curve of the slot as shown in FIG. 3A. The casing treatments 200 have a slot width (CTCircumWid) defined by a circumferential dimension of the casing treatments 200 as measured at the inner surface 150 of the outer casing 104. CTCircumWid represents a maximum circumferential width of a casing treatment groove over all possible axial-cuts where casing treatment 200 is located. In the semicircular slot 200 shown in FIG. 3B, the circumferential width of the groove is the same at all axial cuts (Cut B) and this width is CTCircumWid. As shown in FIG. 3C, a radial height (CTRadHt) of the casing treatments 200 is defined by a distance between the inner surface 150 of the outer casing 104 and the maximum radial dimension of the casing treatment 200. In this way, CTRadHt represents a maximum depth of a casing treatment 200 measured radially.

Referring again to FIG. 3A, another example casing treatment 200′ is shown. Casing treatment 200′ includes a semi-circular leading portion and a tapered trailing portion (indicated by the dashed line). As shown, the maximum depth of casing treatment 200′ is the same as the maximum depth of casing treatment 200. As such, the CTRadHt of casing treatment 200′ is equal to the CTRadHt of casing treatment 200.

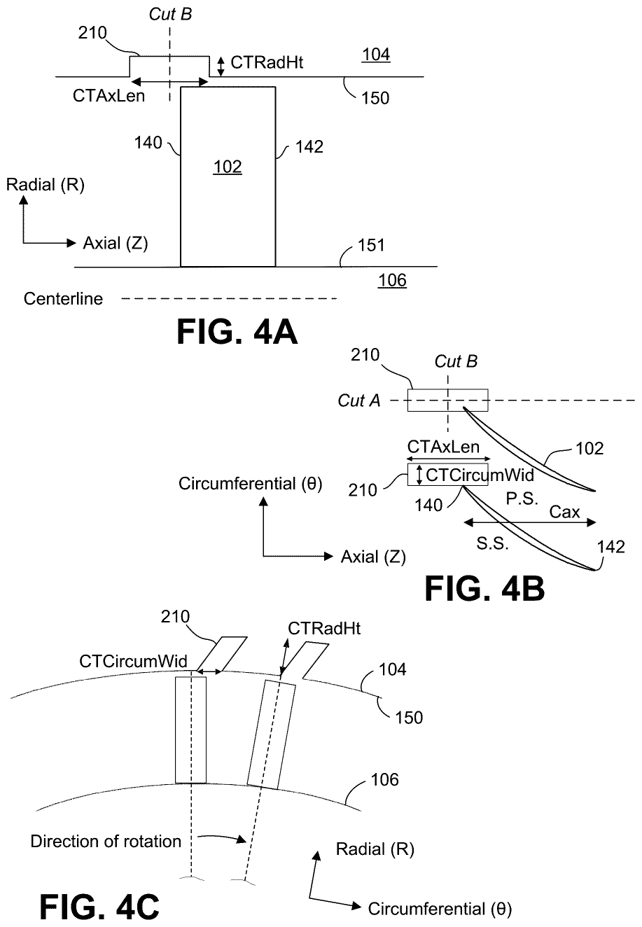

FIGS. 4A through 7C show additional example casing treatments 210, 220, 230, and 240. FIGS. 4A, 4B, and 4C, for example, show casing treatments 210 in the form of axial slots. The casing treatments 210 have a rectangular cross-section when viewed in a circumferential direction (FIG. 4A, cross-section in Cut A in FIG. 4B), a rectangular cross-section when viewed in a radial direction (FIG. 4B), and a skewed parallelogram cross-section when viewed along the axis of rotation (see FIG. 4C, cross-section in Cut B in FIG. 4B). Similar to casing treatments 200, the slots may be skewed approximately 45 degrees relative to the radial direction and in the rotational direction of the blade (e.g., rotor blade 102).

As shown in FIG. 4A, the casing treatments 210 have an axial length (CTAxLen) defined by an axial dimension of the casing treatments 210 as measured at the inner surface 150 of the outer casing 104. CTAxLen represents the maximum axial extent occupied by casing treatment 210 as measured at the inner surface 150 of the outer casing 104. As shown in FIG. 4B, the casing treatments 210 further have a slot width (CTCircumWid) defined by a circumferential dimension of the casing treatments 200 as measured at the inner surface 150 of the outer casing 104. CTCircumWid represents a maximum circumferential width of a casing treatment 210 over all possible axial cuts (Cut B) where casing treatment 210 is located. As shown in FIG. 4C, a radial height (CTRadHt) of the casing treatments 210 is defined by a distance between the inner surface 150 of the outer casing 104 and the maximum radial dimension of the casing treatment 200. In this way, CTRadHt represents a maximum depth of a casing treatment 210 measured in a radial direction.

FIGS. 4A, 4B, and 4C show an exemplary embodiment of the axial slot. Other embodiments of the axial slot are also possible. FIG. 4B shows the major axis of the axial slot aligned with the axial direction. Another embodiment may include a major axis of the axial slot aligned at an angle to the axial direction. Another embodiment may include the direction of the major axis varying with axial position within the slot or with a curved major axis. FIG. 4A depicts an axial slot with a rectangular cross-section. Other embodiments with varying radial depths such as curved or heart-shaped cross-sections are possible. FIG. 4B shows an axial slot with a fixed width in the circumferential direction. Other embodiments in which the circumferential width varies with axial position with the slot are also possible. FIG. 4C shows an embodiment of the axial slot with a skewed parallelogram cross-section when viewed along the rotation axis. Other embodiments with cross-sections where the sharp corners of the skewed parallelogram are smoothed out with a radius of curvature are also possible.

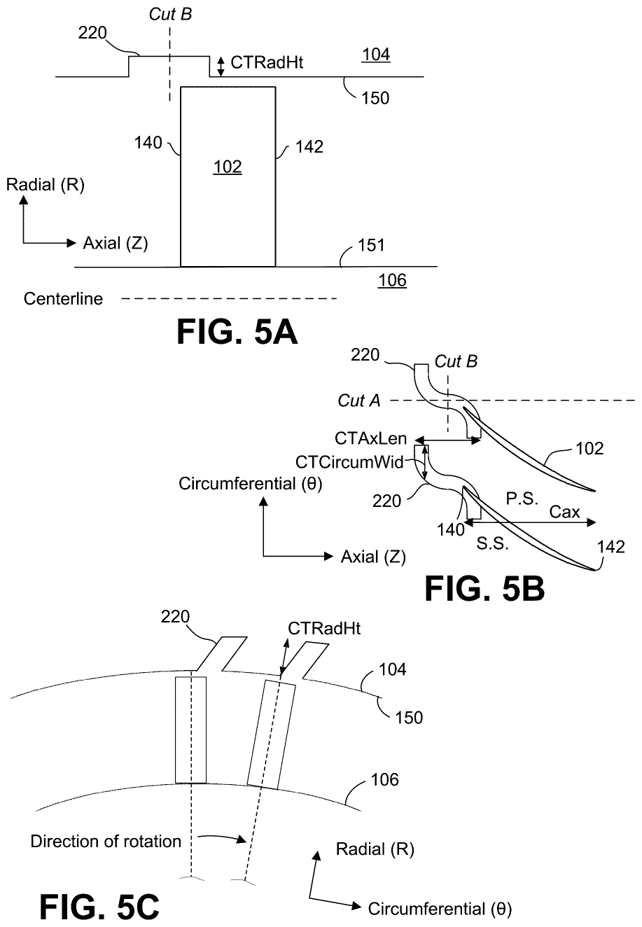

FIG. 5A (cross-section in Cut A in FIG. 5B), 5B, and 5C show casing treatments 220 in the form of “S” grooves. CTAxLen is defined as the maximum axial extent occupied by each casing treatment 220 as measured at the inner surface 150 of the outer casing 104. Hence, as shown in FIG. 5B, the casing treatments 220 have an axial length (CTAxLen) defined in an axial dimension of the casing treatments 220. A slot width (CTCircumWid) of the casing treatments 220 is defined by a circumferential dimension of the casing treatments 220 as measured at the inner surface 150 of the outer casing 104. CTCircumWid represents a maximum circumferential width of a casing treatment 220 over all axial cuts (Cut B) where casing treatment 220 is located. Hence, as shown in FIG. 5B, the casing treatments 220 have a circumferential length (CTCircumWid) defined in a circumferential dimension of the casing treatments 220. As shown in FIG. 5C (cross-section in Cut B in FIG. 5B), a radial height (CTRadHt) of the casing treatments 220 is defined by a distance between the inner surface 150 of the outer casing 104 and the maximum radial dimension of the casing treatment 220.

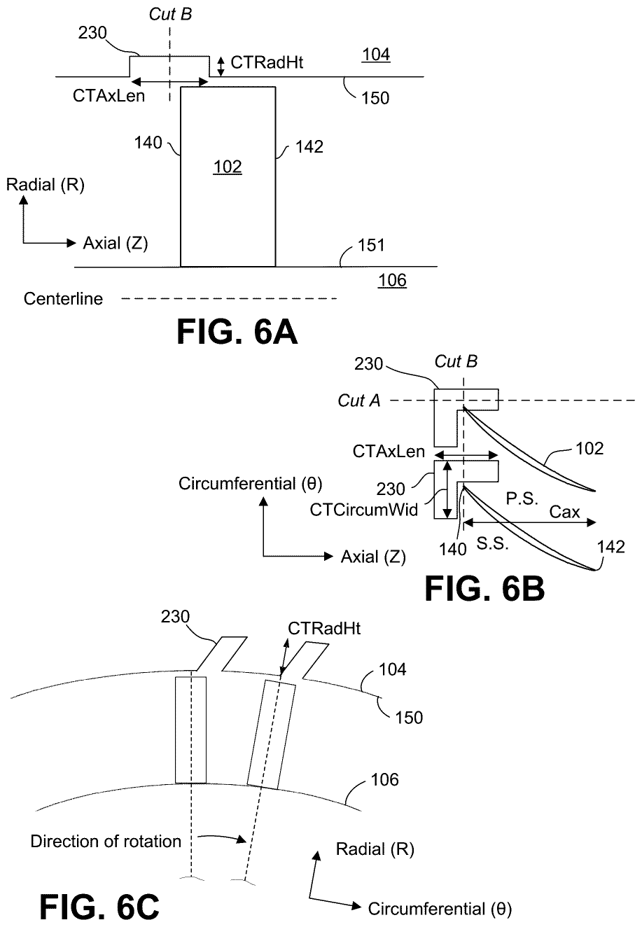

FIG. 6A (cross-section in Cut A in FIG. 6B), 6B, and 6C show casing treatments 230 in the form of “L” grooves. Similar to casing treatments 220, casing treatments 230 have an axial length (CTAxLen) defined in an axial dimension of the casing treatments 230, and a slot width (CTCircumWid) defined by a circumferential dimension of the casing treatments 230 as measured at the inner surface 150 of the outer casing 104. CTAxLen is defined as the maximum axial extent occupied by each casing treatment 230. CTCircumWid represents a maximum circumferential width of a casing treatment 230 over all axial cuts (Cut B) where casing treatment 230 is located. Hence, CTAxLen and CTCircumWid is measured as marked in FIG. 6B. As shown in FIG. 6C (cross-section in Cut B in FIG. 6B), a radial height (CTRadHt) of the casing treatments 230 is defined by a distance between the inner surface 150 of the outer casing 104 and the maximum radial dimension of the casing treatment 230. In this way, CTRadHt represents a maximum depth of a casing treatment 230. The circumferentially-oriented arm portion of the “L” grooves may extend along or opposite to the direction of blade-rotation

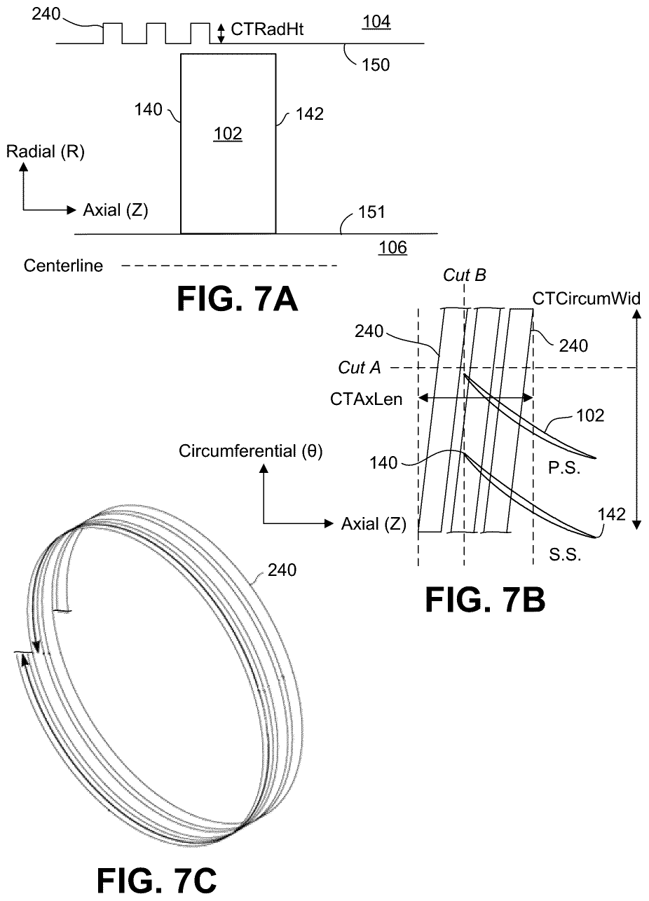

FIGS. 7A, 7B, and 7C show a casing treatment 240 in the form of a spiral groove. Casing treatment 240 has an axial length (CTAxLen) defined in an axial dimension of the casing treatment 240 as shown in FIG. 7B. CTAxLen is the maximum axial extent occupied by the endwall treatment 240. Casing treatment 240 further has a slot width (CTCircumWid as shown in FIG. 7B) that generally corresponds the maximum circumferential width over all axial cuts (Cut B) where casing treatment 240 is located. As shown in FIG. 7A (cross-section in Cut A in FIG. 7B), a radial height (CTRadHt) of the casing treatments 240 is defined by a distance between the inner surface 150 of the outer casing 104 and the maximum radial dimension of the casing treatment 240. In this way, CTRadHt represents a maximum depth of a casing treatment 240. The helix angle associated with this casing treatment can be positive (as shown in FIG. 7B) or negative, in which case the grooves are leaning towards the upstream or negative Z direction in FIG. 7B.)

Referring again to (2), the expression for CTNV, “NCT” is the number of endwall treatments axially closest to the leading edge of the blades of a blade row (e.g., for the embodiment of FIG. 6A, if there are 150 endwall treatments 230, which are axially closest to the blade 102, then NCT is 150. FIG. 7C, showing a spiral groove, has an NCT of 1).

“Cax” is an axial chord length (e.g., rotor or stator blade axial chord length), as shown for example in FIG. 3B. In one approach, Cax is the axial chord length measured in a tip section of a blade. For a rotating blade row (e.g., rotor 120 in FIG. 2), the endwall treatment 162, 164 is generally located in the stationary casing and has a relative motion with respect to the rotating blade row. Hence, for a rotor, the tip section of the blade is the section closest to the stationary casing. For a cantilevered stator (stationary blade row 108 in FIG. 2), the blade row is stationary but the hub is rotating and the endwall treatment 162′, 164′ is located in the rotating hub. Hence, for a stator, the tip section of the blade is the section closest to the rotating hub.

“RotHt” is a blade height. RotHt is the cold rotor blade height measured radially from the leading edge tip of the blade to the leading edge blade root.

“Rtip” is a blade tip radius measured from the leading edge cold tip to the rotation axis. In one approach, Rtip is the blade tip radius measured from a centerline of the rotary component 100 (e.g., centerline 12 of FIG. 1). For a rotor, the tip section of the blade is the section closest to the stationary casing and RTIP=RCASE. For a stator, the tip section of the blade is the section closest to the rotating hub and RTIP=RHUB.

“Mtip” is the blade tip Mach number. Mtip may refer to a rotor blade tip 103 of a rotor blade 102, or a stator vane tip 109 of a stator vane 108.

Mtip=VTIP/c. (3)
C is the speed of sound.

VTIP=(RPM/60)*2*pi*RTIP (3′)

VTIP is the relative velocity between the blade row and the endwall with the endwall treatment. For a rotating blade row (rotor), the speed of blade rotation at the section near the stationary casing is used to determine VTIP. Hence, for a stator, RTIP=RCASE. For a stationary blade row (stator), VTIP refers to the speed at which the hub endwall is rotating relative to the stationary stator. Hence, for a stator, RTIP=RHUB.

RPM is the rotational speed in revolutions per minute and pi (or π) is the transcendental number (3.14159 . . . ) that relates the circumference of a circle with its diameter. The turbomachinery in an aircraft engine can operate at different rotational speed. For the purposes of this patent application, RPM is defined as 90% of the engine redline speed for the shaft in which the compressor is located.

The speed of sound may be determined as follows. For a general fluid, the speed of sound may be calculated as a function of PTA_{BladeIn}, TTA_{BladeIn}, and gas properties (heat capacity, etc.), where PTA_{BladeIn} is the absolute total pressure and TTA_{BladeIn} is the absolute total temperature at the inlet to the blade where the casing treatment is located. For an idealized gas, c may be determined from (4):

c=(γ*R*TTA_{Bladein})^{1/2} (4)

Where “γ” is the heat capacity ratio for an ideal gas (e.g., approximately 1.4 for air), “R” is a gas constant (e.g., approximately 287 J/kgK for air), and “TTA_{BladeIn}” is the absolute total temperature at the inlet to the blade where the casing treatment is located. Embodiments disclosed herein model the gas as an idealized (4).

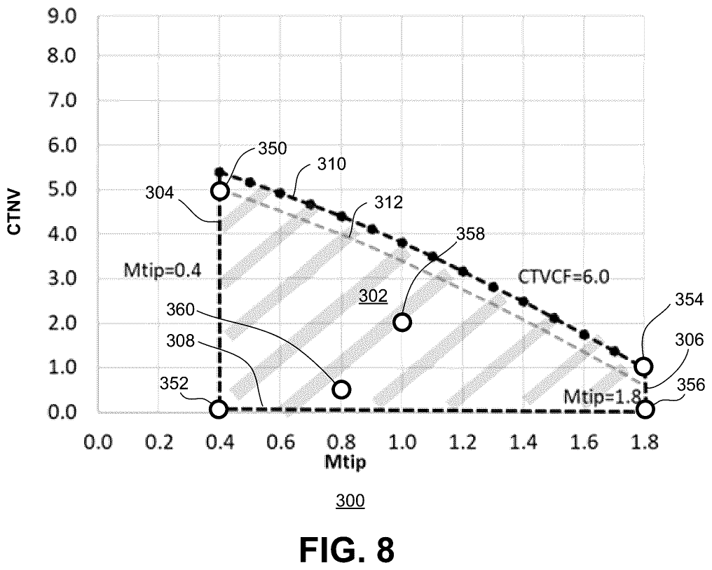

FIG. 8 is a graph 300 that plots casing treatment normalized volume (CTNV) along the Y axis vs. blade tip Mach number (Mtip) along the X axis. The inventors found that with increased fluid compressibility (i.e., Mtip value along the X axis), smaller normalized casing treatment volumes (CTNV) are needed to better balance casing treatment aerodynamic benefits such as stall-margin improvement with penalties such as increased manufacturing costs and increased casing weight. More particularly, the inventors found that choosing a CTNV for an associated Mtip value within a design space 302 (shaded area in FIG. 8) will yield a favorable volume in terms of overall casing weight, manufacturing, and aerodynamic benefit (e.g., improved stall-margin). In the alternative, choosing a parameter outside of the shaded design space 302 may require a larger casing treatment that will tend to sacrifice these benefits.

By one approach, the inventors determined that it can be beneficial to constrain Mtip to a range of 0.4 to 1.8, as indicated by X axis minimum and maximum bounding lines 304, 306. By another approach, the inventors determined that it can be beneficial to constrain Mtip to a range of 0.4 to 0.9 relevant to rear-stage high-pressure compressors, or to the range of 0.9 to 1.8 relevant to front-stage high-pressure compressors, boosters, and fans. For example, a first, second, third, fourth and up to fifth upstream stages of the high pressure compressor (i.e., those nearest the inlet) are constrained so that Mtip is within a range of 0.9 to 1.8, and a sixth, seventh, eighth, ninth, and tenth downstream stage of the high speed compressor (i.e., those nearest the outlet) are constrained so that Mtip is within a range of 0.4 to 0.9.

The inventors further determined that a given casing treatment volume would result in a suitable stall margin when the normalized volume (CTNV) is above a minimum threshold (e.g., 0.0001, 0.001 or 0.01 depending on the application, as indicated at minimum CTNV bounding line 308), and is below a line defined by a casing treatment volume compressibility factor (CTVCF). A CTVCF of 6.0 forms an upper (e.g., maximum) boundary of the design space along the Y axis, as indicated by bounding line 310, and a lower (e.g., minimum) boundary equal to or greater than 0.6. The resulting design space 302 includes Mtip values within a range of 0.4 to 1.8 and CTNV having maximum values that are bounded on the Y axis by a casing treatment volume compressibility factor (CTVCF) of 6.0.

In another approach, CTNV values are bounded on the Y axis by a casing treatment volume compressibility factor (CTVCF) less than or equal to 6.0 and equal to or greater than 0.6. For example, bounding line 312 corresponds to a CTVCF value of 5.6. Other CTVCF values such as 5.0, 4.0, 3.0, 2.0, 1.0, or 0.1, or values therebetween, may be selected as to define the curve representing the upper boundary of the volume design space, depending on the use situation. The lower bound for CTNV in these cases may be 0.0001, 0.001, or 0.01 depending on the application.

Example casing treatments are provided in Table 1 below, with the first 6 examples plotted in the graph 300 of FIG. 8.

TABLE 1

| Example | CTAxLen/ | CTRad/ | CTCircumWid/ | | | | | |
|---|---|---|---|---|---|---|---|---|
| (FIG. 8) | Cax | RotHt | (2*pi*Rtip) | NCT | CTNV | Mtip | CTVCF | CT Shape |
| 350 | 0.5 | 0.2 | 0.00312 | 160 | 4.990 | 0.4 | 5.60 | Semi-circ. |
| 352 | 0.5 | 0.2 | 0.00312 | 1 | 0.031188 | 0.4 | 0.64 | Ax. Slot |
| 354 | 0.2 | 0.1 | 0.00516 | 96 | 0.990 | 1.8 | 6.00 | Ax. Slot |
| 356 | 0.05 | 0.01 | 0.002 | 1 | 0.00010 | 1.8 | 5.01 | Semi-Circ. |
| 358 | 0.4 | 0.1 | 0.00521 | 96 | 2.000 | 1.0 | 4.20 | Ax. Slot |
| 360 | 0.222 | 0.02 | 0.9 | 1 | 0.400 | 0.8 | 2.01 | Spiraling |
| | | | | | | | | Groove |
| | 0.54 | 0.2 | 0.00100 | 500 | 5.389 | 0.4 | 6.00 | L-Shaped |
| | 1 | 0.1 | 0.00313 | 160 | 5.000 | 0.4 | 5.61 | Semi-Circ. |
| | 0.012 | 0.01 | 0.8 | 1 | 0.010 | 1.8 | 5.02 | Spiraling |
| | | | | | | | | groove |
| | 0.4 | 0.1 | 0.00063 | 160 | 0.400 | 1.8 | 5.41 | Ax. Slot |

Example 350 generally corresponds to casing treatments in the form of semi-circular shapes (e.g., as discussed with respect to FIGS. 3A, 3B, and 3C). As shown, Example 350 has an Mtip value of 0.4 and a CTNV value of 4.99. Thus, Example 350 is plotted along Mtip bounding line 304 and above minimum CTNV bounding line 308. As Example 350 is below CTVCF bounding line 310 and at CTVCF bounding line 312, Example 350 is within design space 302 at or proximate a maximum CTNV boundary and a minimum Mtip boundary.

Example 352 generally corresponds to casing treatments in the form of axial slots (e.g., as discussed with respect to FIGS. 4A, 4B, and 4C). Example 352 has an Mtip value of 0.4 and has a CTNV value of 0.031. Thus, Example 352 is plotted along Mtip bounding line 304 and above minimum CTNV bounding line 308. Example 352 is therefore at or proximate a minimum CTNV boundary and a minimum Mtip boundary. As Example 352 is below both CTVCF bounding line 310 and CTVCF bounding line 312, Example 352 is within design space 302.

Example 354 generally corresponds to casing treatments in the form of axial slots (e.g., as discussed with respect to FIGS. 4A, 4B, and 4C). Example 354 has an Mtip value of 1.8 and a CTNV value of 0.99. Thus, Example 354 is plotted along Mtip bounding line 306 and above minimum CTNV bounding line 308. As Example 354 is at CTVCF bounding line 310, Example 354 is within design space 302 at a maximum CTNV boundary and a maximum Mtip boundary.

Example 356 generally corresponds to casing treatments in the form of semi-circular shapes (e.g., as discussed with respect to FIGS. 3A, 3B, and 3C). Example 356 has an Mtip value of 1.8 and a CTNV value of 0.0001. Thus, Example 354 is plotted along Mtip bounding line 306 and at minimum CTNV bounding line 308. Example 356 is therefore at or proximate a minimum CTNV boundary and a maximum Mtip boundary. As Example 356 is below both CTVCF bounding line 310 and CTVCF bounding line 312, Example 356 is within design space 302.

Example 358 generally corresponds to casing treatments in the form of axial slots (e.g., as discussed with respect to FIGS. 4A, 4B, and 4C). Example 358 has an Mtip value of 1.0 and a CTNV value of 2.0. Thus, Example 358 is plotted between Mtip bounding lines 304 and 306, and above CTNV bounding line 308. As Example 358 is below CTVCF bounding lines 310 and 312, Example 358 is within a middle region of design space 302.

Example 360 generally corresponds to casing treatments in the form of spiral grooves (e.g., as discussed with respect to FIGS. 7A, 7B, and 7C). Example 360 has an Mtip value of 0.8 and a CTNV value of 0.400. Thus, Example 360 is plotted between Mtip bounding lines 304 and 306, and above CTNV bounding lines 308. As Example 360 is also below CTVCF bounding lines 310 and 312, Example 360 is within a middle region of design space 302.

In view of the foregoing discussion and examples provided, it will be understood that using characteristics of the rotary component (e.g., Cax, RotHt, Rtip, and Mtip), values influencing the selection of CTNV may be determined (i.e., NCT, CTAxLen, CTRadHt, and CTCircumWid) so that the resulting casing treatment normalized volume (CTNV) value as determined from (2) or (2′) falls within the desired design space 302 (FIG. 8). The inventors believe that a CTNV that falls outside of design space 302 may be indicative of a casing treatment volume not desirable for a given Mtip value or blade features, based on their testing and experiments with endwall casing treatments.

Table 2 provides ranges for the physical characteristics of the endwall treatment and rotary member where CTNV applies.

TABLE 2

| | |
|---|---|
| Range 1 | Range 2 |

| Variable | Min | Max | Min | Max |
|---|---|---|---|---|
| CTAxLen/Cax | 0.01 | 1 | 0.05 | 0.8 |
| CTRad/RotHt | 0.01 | 0.2 | 0.01 | 0.2 |
| CTWid/(2*pi*Rtip) | 0.0006 | 1 | 0.001 | 1 |
| NCT | 1 | 500 | 8 | 400 |
| CTNV | 0.0001 | 5.5 | | |
| MTIP | 0.4 | 1.8 | 0.4 | 1.6 |
| CTVCF | 0.6 | 6 | 0.61 | 5.6 |

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A turbomachine for an aircraft comprising: a plurality of radially-extending blades; and an annular endwall opposite the radially-extending blades, the endwall including an endwall treatment recessed into the endwall, the endwall treatment having a casing treatment volume compressibility factor (CTVCF), a casing treatment normalized volume (CTNV), and a blade tip Mach number (Mtip) according to:

CTVCF=CTNV+2.2*Mtip^{1.4}

wherein CTNV=100*(CTAxLen/Cax)*(CTRadHt/RotHt)*(CTCircumWid*NCT/(2*pi*Rtip)),
wherein:
   CTAxLen is a maximum axial extent occupied by each endwall treatment,
   CTRadHt is a radial height between a distance from a surface of the annular endwall and a maximum radial dimension of the endwall treatment from the surface,
   CTCircumWid is a maximum circumferential dimension of the endwall treatment over all possible axial cuts where the endwall treatment is located,
   NCT is a number of endwall treatment slots over an entire circumference around a blade row,
   Cax is a blade axial chord length measured in a tip section of a blade closest to the endwall with the endwall treatment,
   RotHt is a blade height, and
   Rtip is a blade tip radius, and
wherein Mtip is a blade tip Mach number=(relative speed between blade tip and endwall with endwall treatment while rotating at 90% of the engine redline speed for the shaft in which the compressor is located)/(speed of sound), and
wherein CTVCF is less than or equal to 6.0 and greater than 0.6.

The turbomachine of one or more of these clauses, wherein the turbomachine is an aircraft gas turbine engine.

The turbomachine of one or more of these clauses, wherein the endwall treatment includes at least one of: a semi-circular slot; an axial slot; an S-shaped slot; an L-shaped slot; and a spiral groove slot.

The turbomachine of one or more of these clauses, wherein CTVCF is less than or equal to 5.6 and greater than 0.61.

The turbomachine of one or more of these clauses, wherein Mtip is within a range of 0.4 to 1.8, 0.4 to 1.6, 0.4 to 0.9 or 0.9 to 1.8.

The turbomachine of one or more of these clauses, wherein NCT is within a range of 1.0 to 500.

The turbomachine of one or more of these clauses, wherein CTNV is within a range of 0.0001 to 5.5, or 0.0001 to 4.0.

The turbomachine of one or more of these clauses, wherein CTAxLen/Cax is within a range of 0.01 to 1.0 or 0.05 to 0.8.

The turbomachine of one or more of these clauses, wherein CTRadHt/RotHt is within a range of 0.01 to 0.2.

The turbomachine of one or more of these clauses, wherein CTWid/(2*pi*Rtip) is within a range of 0.0006 to 1.0, or 0.001 to 1.0.

The turbomachine of one or more of these clauses, wherein the plurality of radially-extending blades include rotor blades and the annular endwall includes an outer casing endwall opposite tips of the rotor blades.

The turbomachine of one or more of these clauses, wherein the plurality of radially-extending blades includes stator blades and the annular endwall includes a hub endwall opposite tips of the stator blades.

The turbomachine of one or more of these clauses, wherein the annular endwall is a fan casing, the endwall treatment recessed into the fan casing.

The turbomachine of one or more of these clauses, wherein the annular endwall is a low-pressure compressor casing, the endwall treatment recessed into the low-pressure compressor casing.

The turbomachine of one or more of these clauses, wherein the annular endwall is a high-pressure compressor casing, the endwall treatment recessed into the high-pressure compressor casing.

The turbomachine of one or more of these clauses, wherein the annular endwall is an intermediate-pressure compressor casing, the endwall treatment recessed into the intermediate-pressure compressor casing.

A method of assembly of an aircraft turbomachine, comprising:
mounting a plurality of radially-extending blades relative an annular endwall of a compressor or fan to assemble an aircraft gas turbine engine, wherein the endwall includes an endwall treatment recessed into the endwall, the endwall treatment having a casing treatment volume compressibility factor (CTVCF), a casing treatment normalized volume (CTNV), and a fluid compressibility (Mtip) according to:

CTVCF=CTNV+2.2*Mtip^{1.4}

wherein CTNV=100*(CTAxLen/Cax)*(CTRadHt/RotHt)*(CTCircumWid*NCT/(2*pi*Rtip)),
wherein:
   CTAxLen is a maximum axial extent occupied by each endwall treatment,
   CTRadHt is a radial height between a distance from a surface of the annular endwall and a furthest radial dimension of the endwall treatment from the surface,
   CTCircumWid is a maximum circumferential dimension of the endwall treatment over all axial cuts where endwall treatment is located,
   NCT is a number of endwall treatment slots over the entire circumference around a blade row,
   Cax is a blade axial chord length measured in a tip section of a blade closest to the endwall with the endwall treatment,
   RotHt is a blade height, and
   Rtip is a blade tip radius, and
wherein Mtip is a blade tip Mach number=(relative speed between blade tip and endwall with endwall treatment while rotating at 90% of the engine redline speed for the shaft in which the compressor or fan is located)/(speed of sound), and
wherein CTVCF is less than or equal to 6.0 and greater than 0.6.

The method of one or more of these clauses, wherein the endwall treatment includes at least one of: a semi-circular slot; an axial slot; an S-shaped slot; an L-shaped slot; and a spiral groove slot.

The method of one or more of these clauses, wherein CTVCF is less than or equal to 5.6 and greater than 0.61.

The method of one or more of these clauses, wherein Mtip is within a range of 0.4 to 1.8, 0.4 to 1.6, 0.4 to 0.9 or 0.9 to 1.8.

The method of one or more of these clauses, wherein NCT is within a range of 1.0 to 500 or 8.0 to 400.

The method of one or more of these clauses, wherein CTNV is within a range of 0.0001 to 5.5, or 0.0001 to 4.0.

The method of one or more of these clauses, wherein CTAxLen/Cax is within a range of 0.01 to 1.0, or 0.05 to 0.8.

The method of one or more of these clauses, wherein CTRadHt/RotHt is within a range of 0.01 to 0.2.

The method of one or more of these clauses, wherein CTWid/(2*pi*Rtip) is within a range of 0.0006 to 1.0, or 0.001 to 1.0.

The method of one or more of these clauses, wherein the plurality of radially-extending blades include rotor blades and the annular endwall includes an outer casing endwall opposite tips of the rotor blades.

The method of one or more of these clauses, wherein the plurality of radially-extending blades includes stator blades and the annular endwall includes a hub endwall opposite tips of the stator blades.

The method of one or more of these clauses, wherein the annular endwall is a fan casing, the endwall treatment recessed into the fan casing.

The method of one or more of these clauses, wherein the annular endwall is a low-pressure compressor casing, the endwall treatment recessed into the low-pressure compressor casing.

The method of one or more of these clauses, wherein the annular endwall is a high-pressure compressor casing, the endwall treatment recessed into the high-pressure compressor casing.

The method of one or more of these clauses, wherein the annular endwall is an intermediate-pressure compressor casing, the endwall treatment recessed into the intermediate-pressure compressor casing.

1. A turbomachine for an aircraft, comprising:
a plurality of radially-extending blades; and
an annular endwall opposite the plurality of radially-extending blades, the annular endwall including an endwall treatment recessed into the annular endwall, the endwall treatment having a casing treatment volume compressibility factor (CTVCF), and a casing treatment normalized volume (CTNV) according to:
CTVCF=CTNV+2.2*Mtip^{1.4},
wherein CTNV=100*(CTAxLen/Cax)*(CTRadHt/RotHt)*(CTCircumWid*NCT/(2*pi*Rtip)),
wherein:
CTAxLen is a maximum axial extent occupied by the endwall treatment,
CTRadHt is a radial height between a distance from a surface of the annular endwall and a furthest radial dimension of the endwall treatment from the surface,
CTCircumWid is a maximum circumferential dimension of the endwall treatment over axial cuts where the endwall treatment is located,
NCT is a number of endwall treatment slots over an entire circumference around a blade row,
Cax is a blade axial chord length,
RotHt is a blade height, and
Rtip is a blade tip radius,
wherein Mtip is a blade tip Mach number=(relative speed between blade tip and endwall with endwall treatment while rotating at 90% of an engine redline speed)/(speed of sound), and
wherein CTVCF is less than or equal to 6.0 and greater than 0.6, and Mtip is within a range of 0.4 to 1.8.

2. The turbomachine of claim 1, wherein CTVCF is less than or equal to 5.6 and greater than 0.61.

3. The turbomachine of claim 1, wherein the turbomachine is an aircraft gas turbine engine, further comprising a core engine including, in serial flow relationship, a low pressure compressor section, a high pressure compressor section, a combustion section and a turbine section,
the high pressure compressor section having from 8 to 10 compressor stages, each of the compressor stages comprising a plurality of radially-extending blades, and
wherein at least one of the low pressure and high pressure compressor sections comprises the annular endwall, the plurality of radially-extending blades, the casing treatment volume compressibility factor (CTVCF), and the casing treatment normalized volume (CTNV).

4. The turbomachine of claim 1, wherein the endwall treatment includes at least one of:
a semi-circular slot;
an axial slot;
an S-shaped slot;
an L-shaped slot; and
a spiral groove slot.

5. The turbomachine of claim 1, wherein M tip is within a range of 0.4 to 1.6.

6. The turbomachine of claim 1, wherein NCT is within a range of 1 to 500.

7. The turbomachine of claim 1, wherein CTNV is within a range of 0.0001 to 5.5.

8. The turbomachine of claim 1, wherein the plurality of radially-extending blades include rotor blades and the annular endwall includes an outer casing endwall opposite tips of the rotor blades.

9. The turbomachine of claim 1, wherein the plurality of radially-extending blades include stator blades and the annular endwall includes a hub endwall opposite tips of the stator blades.

10. The turbomachine of claim 1, further comprising an electrically driven ducted fan or rotor comprising a rotary component of the turbomachine.

11. A method of assembly, comprising:
mounting a plurality of radially-extending blades relative an annular endwall of a compressor or fan to assemble an aircraft gas turbine engine, wherein the annular endwall includes an endwall treatment recessed into the annular endwall, the endwall treatment having a casing treatment volume compressibility factor (CTVCF), and casing treatment normalized volume (CTNV) according to:
CTVCF=CTNV+2.2*Mtip^{1.4},
wherein CTNV=100*(CTAxLen/Cax)*(CTRadHt/RotHt)*(CTCircumWid*NCT/(2*pi*Rtip)),
wherein:
CTAxLen is a maximum axial extent occupied by the endwall treatments,
CTRadHt is a radial height between a distance from a surface of the annular endwall and a maximum radial dimension of the endwall treatment from the surface,
CTCircumWid is a maximum circumferential dimension of the endwall treatment over all axial cuts where the endwall treatments are located, NCT is a number of endwall treatment slots over an entire circumference around a blade row,
Cax is a blade axial chord length measured in a tip section of a blade closest to the endwall with the endwall treatment,
RotHt is a blade height, and
Rtip is a blade tip radius,
wherein Mtip is a blade tip Mach number=(relative speed between the blade tip and the endwall with endwall treatment while rotating at 90% of an engine redline speed)/(speed of sound), and
wherein CTVCF is less than or equal to 6.0 and greater than 0.6, and Mtip is within a range of 0.4 to 1.8.

12. A turbomachine for an aircraft, comprising:
a fan assembly including a plurality of fan blades;
a core engine including, in serial flow relationship, a low pressure compressor section, a high pressure compressor, a combustion section and a turbine section;
the high pressure compressor section having from 8 to 10 compressor stages, each of the compressor stages comprising a plurality of radially-extending blades, the compressor stages being contained within a compressor casing comprising an annular endwall opposite the plurality of radially-extending blades, the annular endwall including an endwall treatment recessed into the annular endwall, the endwall treatment having a casing treatment volume compressibility factor (CTVCF), and a casing treatment normalized volume (CTNV) according to:
CTVCF=CTNV+2.2*Mtip^{1.4},
wherein CTNV=100*(CTAxLen/Cax)*(CTRadHt/RotHt)*(CTCircumWid*NCT/(2*pi*Rtip)),
wherein:
Mtip is a blade tip Mach number for one of the plurality of radially-extending blades,
CTAxLen is a maximum length of the endwall treatment in an axial direction,
CTRadHt is a radial height between a distance from a surface of the annular endwall and a furthest radial dimension of the endwall treatment from the surface,
CTCircumWid is a maximum circumferential dimension of the endwall treatment,
NCT is a number of endwall treatment slots over an entire circumference around a blade row,
Cax is a blade axial chord length,
RotHt is a blade height, and
Rtip is a blade tip radius; and
wherein Mtip is within a range of 0.4 to 1.8,
wherein CTVCF is less than or equal to 6.0 and greater than 0.6, and Mtip is within a range of 0.4 to 1.8.

13. The turbomachine of claim 12, wherein NCT is within a range of 1 to 500.

14. The turbomachine of claim 12, wherein CTVCF is such that Mtip is within a range of 0.9 to 1.8 for a front stage of the high pressure compressor located proximal to an inlet of the high pressure compressor and distal an outlet of the compressor.

15. The turbomachine of claim 12, wherein CTVCF is such that Mtip is within a range of 0.4 to 0.9 for a rear stage of the high pressure compressor located proximal to an outlet of the high pressure compressor and distal of an inlet to the high pressure compressor.
